(19) United States
(12) Patent Application Publication
(10) Pub. No.: US 2023/0154302 A1
(43) Pub. Date: May 18, 2023

(54) ADDRESS-TYPE FIRE DETECTION DEVICE AND ADDRESS-TYPE FIRE DETECTION SYSTEM COMPRISING SAME

(71) Applicant: NEOSNT INC., Daegu (KR)

(72) Inventor: Seong Mo KOO, Daegu (KR)

(73) Assignee: NEOSNT INC., Daegu (KR)

(21) Appl. No.: 17/920,632

(22) PCT Filed: Apr. 1, 2021
(86) PCT No.: PCT/KR2021/004040

§ 371 Date: Oct. 21, 2022

(30) Foreign Application Priority Data
Apr. 27, 2020 (KR) 10-2020-0050459

(51) Int. Cl. G08B 17/06; G08B 25/00

(52) U.S. Cl. CPC G08B 17/06; G08B 25/007

(57) ABSTRACT

An address-type fire detection device includes: a fire detection sensor provided at a location where fire is to be detected, so as to detect fire; an operation signal generating unit for generating, when fire is detected through the fire detection sensor, an operation signal including a first pulse that has a first frequency corresponding to an address value assigned to the location where fire is to be detected; and an electrical signal generating unit for generating an electrical signal, including the first frequency, according to the control of the operation signal.

### CROSS-REFERENCE TO PRIOR APPLICATIONS

This application is a National Stage Patent Application of PCT International Patent Application No. PCT/KR2021/004040 (filed on Apr. 1, 2021) under 35 U.S.C. § 371, which claims priority to Korean Patent Application No. 10-2020-0050459 (filed on Apr. 27, 2020), which are all hereby incorporated by reference in their entirety.

### BACKGROUND

The disclosure relates generally to an address-type fire detection device and an address-type fire detection system including the same and, more particularly, to an address-type fire detection device and an address-type fire detection system including the same, capable of determining a location where fire has occurred using a first frequency to which a different frequency value is given for each address value assigned to a location where fire is to be detected.

People continue to make efforts in present as well as in the past to protect their lives and properties from fires.

Recently, with the social development and improvements in living standards, there are many large buildings having complex internal structures and partitioned internal structures so that many people may use different facilities.

When fire occurs in a large building, it is difficult to determine a location where fire has occurred due to a complex internal structure, thus frequently causing huge losses of both life and property.

Thus, when fire occurs in a building or a facility used by many people, it is necessary to determine the exact location of the fire, and technical development is in progress for this purpose.

As the prior art related to technology for detecting the location of fire, Korean Patent KR 10-1100255 entitled “User-oriented addressable P-type automatic fire detection system”, Korean Patent KR 10-1655827 entitled “Addressable repeater and addressable manual call point based on location confirmation”, etc. have been proposed. The prior art provides a technology in which an address signal of a location where the fire is detected is transmitted through communication when the fire is detected, and then a location where the fire occurs is detected. The prior art is a technology for detecting a location where fire occurs through communication, and is problematic in that a new communication facility for transmitting an address signal of a location where fire is detected through communication should be established in addition to a power line for supplying power to a fire detector, thus incurring high construction costs.

### SUMMARY

The present disclosure has been made keep in mind the above problems occurring in the prior art, and an objective of the present disclosure is to provide an address-type fire detection device and an address-type fire detection system including the same, capable of determining a location where fire has occurred only with a power line without the necessity of providing a separate communication line or communication facility.

In an aspect, an address-type fire detection device is disclosed. The address-type fire detection device includes a fire detection sensor provided at a location where fire is to be detected, so as to detect fire, an operation signal generating unit for generating, when fire is detected through the fire detection sensor, an operation signal including a first pulse that has a first frequency corresponding to an address value assigned to the location where fire is to be detected, and an electrical signal generating unit for generating an electrical signal, including the first frequency, according to the control of the operation signal.

The operation signal generated by the operation signal generating unit may include a second pulse having a second frequency. In this case, the first frequency may have a value greater than the second frequency. The second pulse may have a first section and a second section. The first pulse may be applied in a pulse-burst to the first section. The electrical signal generating unit may generate the electrical signal including the first frequency by the first pulse applied to the first section.

For example, the operation signal generating unit may include an address setting part setting the address value assigned to the location where fire is to be detected, a calculation determining part calculating the first frequency corresponding to the address value and determining whether the operation signal is generated, after receiving the address value set by the address setting part and the fire signal detected through the fire detection sensor, and a pulse-burst signal generator generating the operation signal according to the control of the calculation determining part. The pulse-burst signal generator may generate the first pulse having the first frequency and the second pulse having the second frequency, and may generate the operation signal by applying the first pulse to the first section of the second pulse in the pulse-burst.

For example, the electrical signal generating unit may include a current source providing a current, and a switch connected to the current source to turn on or off the supply of the current that is provided by the current source. In this case, the operation signal may be applied as a switching signal of the switch. The electrical signal including the first frequency, which is generated by the electrical signal generating unit, may be reflected in the form of a change in a current value of the current provided by the current source.

The address-type fire detection device may further include a power line supplying power required for operating the electrical signal generating unit. In this case, the electrical signal including the first frequency, generated by the electrical signal generating unit, may be provided to the power line.

In another aspect, an address-type fire detection system is disclosed. The address-type fire detection system includes a plurality of address-type fire detection devices which are distributed according to a location where fire is to be detected, and to which different address values are assigned by distributed location, a power line connected to the plurality of address-type fire detection devices to supply power required for operation, and a receiving part connected to the power line to determine whether fire has broken out at each location where fire is to be detected.

Each of the plurality of address-type fire detection devices includes a fire detection sensor provided at a location where fire is to be detected to detect fire, an operation signal generating unit generating an operation signal including a first pulse having a first frequency that is a frequency corresponding to the address value assigned to the location where fire is to be detected if fire is detected by the fire detection sensor, and an electrical signal generating unit generating an electrical signal including the first frequency according to the control of the operation signal. In this case, the first frequency has different frequency values if the address values are different from each other. The electrical signal including the first frequency, generated by the electrical signal generating unit, is provided through the power line.

The operation signal generated by the operation signal generating unit may include a second pulse having a second frequency. In this case, the first frequency may have a value greater than the second frequency. The second pulse may have a first section and a second section. The first pulse may be applied in a pulse-burst to the first section. The electrical signal generating unit may generate the electrical signal including the first frequency by the first pulse applied to the first section.

For example, the operation signal generating unit may include an address setting part setting the address value assigned to the location where fire is to be detected, a calculation determining part calculating the first frequency corresponding to the address value and determining whether the operation signal is generated, after receiving the address value set by the address setting part and the fire signal detected through the fire detection sensor, and a pulse-burst signal generator generating the operation signal according to the control of the calculation determining part. The pulse-burst signal generator may generate the first pulse having the first frequency and the second pulse having the second frequency, and may generate the operation signal by applying the first pulse to the first section of the second pulse in the pulse-burst.

Meanwhile, the second frequency may have different frequency values if the address values are different from each other Further, the electrical signal including the first frequency, generated by the electrical signal generating unit, may include a current provided to the power line. The electrical signal generating unit of each of the plurality of address-type fire detection devices may be electrically connected in parallel to the power line.

The receiving part may include a voltage conversion part connected to the power line to convert the current flowing through the power line to voltage, and a fire determination part analyzing the frequency of the voltage converted by the voltage conversion part and then determining whether fire occurs for each location where fire is to be detected from the analyzed frequency of the voltage.

For example, the electrical signal generating unit may include a current source connected to the power line to provide a current to the power line, and a switch connected to the current source to turn on or off the supply of the current that is provided by the current source. In this case, the operation signal may be applied as a switching signal of the switch. The electrical signal including the first frequency, which is generated by the electrical signal generating unit, may be reflected in the form of a change in a current value of the current provided to the power line by the current source.

The present disclosure is advantageous in that an electrical signal including a first frequency is generated by controlling an electrical signal generating unit through an operation signal that is generated by an operation signal generating unit and includes a first pulse having the first frequency that is a frequency corresponding to an address value, thus facilitating an operation only by a power line.

Further, the present disclosure is advantageous in that it is possible to check whether fire has occurred for each location where fire is to be detected only by analyzing a frequency at a receiving end using a first frequency having a different frequency value for each address value.

Further, the present disclosure is advantageous in that it is possible to check whether fire has occurred for each location where fire is to be detected only by analyzing a frequency even if fires have simultaneously occurred at a plurality of locations where fire is to be detected, through an operation signal including a second frequency having a different frequency value for each address value.

The foregoing provides only optional concepts in a simplified form for matters that are to be described in more detail later. It is not intended to limit key features or essential features of the claims, or to limit the scope of the claims.

### BRIEF DESCRIPTION OF THE DRAWINGS

FIG. 1 is a diagram illustrating an example of an address-type fire detection device according to an embodiment of the present disclosure.

FIG. 2 is a diagram illustrating another example of an address-type fire detection device according to an embodiment of the present disclosure.

FIG. 3 is a diagram illustrating a further example of an address-type fire detection device according to an embodiment of the present disclosure.

FIGS. 4 to 7 are diagrams illustrating various examples of operation signals generated by an operation signal generating unit according to the present disclosure.

FIGS. 8 to 10 are diagrams illustrating various examples of electrical signals generated by an electrical signal generating unit of the address-type fire detection device according to the present disclosure.

FIG. 11 is a diagram illustrating an example of an address-type fire detection system according to another embodiment of the present disclosure.

FIG. 12 is a diagram illustrating an example of a receiving end according to the present disclosure.

### DETAILED DESCRIPTION

Hereinafter, embodiments of the present disclosure will be described in detail with reference to the accompanying drawings. Unless otherwise specified in the text, like reference numbers in the drawings indicate like components. The exemplary embodiments described above in the detailed description, drawings, and claims are not for limitation, other embodiments may be used, and other changes are possible without departing from the spirit or scope of the technology disclosed herein. It is apparent to those skilled in the art that components of the present disclosure, i.e., components generally described and illustrated in the drawings are arranged, configured, coupled, and designed in various different configurations, and form a part of the present disclosure. In the drawings, in order to clearly express various layers (or films), areas and shapes, the width, length, thickness, or shape of the component may be exaggerated.

It will be understood that when a component is referred to as being “arranged” on another component, it can be directly arranged on the other component or intervening components may be present therebetween.

It will be understood that when a component is referred to as being “provided” on another component, it can be directly provided on the other component or intervening components may be present therebetween.

Structural or functional descriptions in the embodiments of the present disclosure are only for description of the embodiments of the present disclosure. The descriptions should not be construed as being limited to the embodiments described in the specification or application. The present disclosure may, however, be embodied in many different forms and should not be construed as being limited to only the embodiments set forth herein, but should be construed as covering modifications, equivalents or alternatives falling within ideas and technical scopes of the present disclosure.

The singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations thereof but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

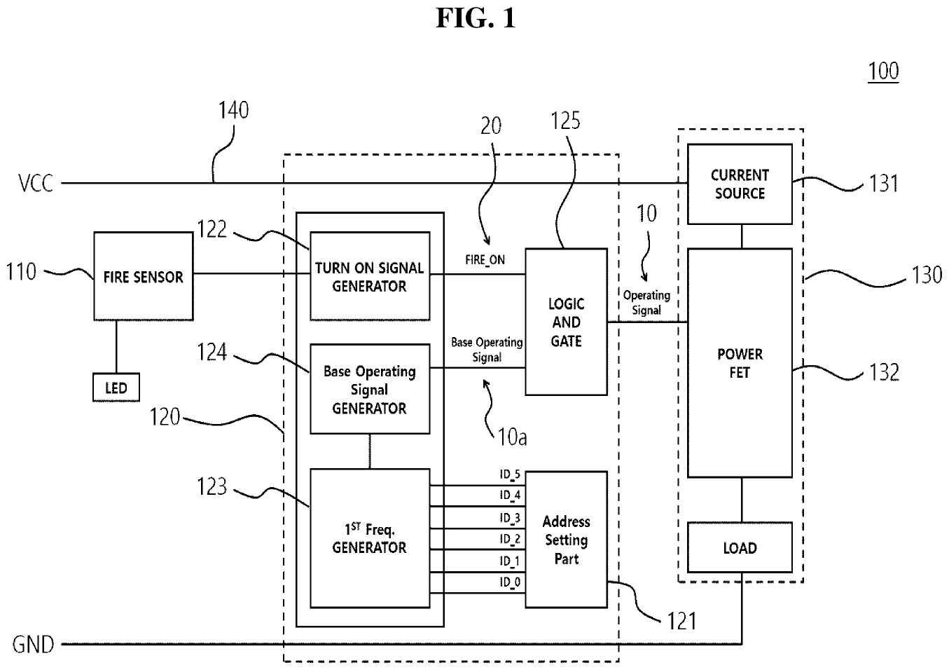

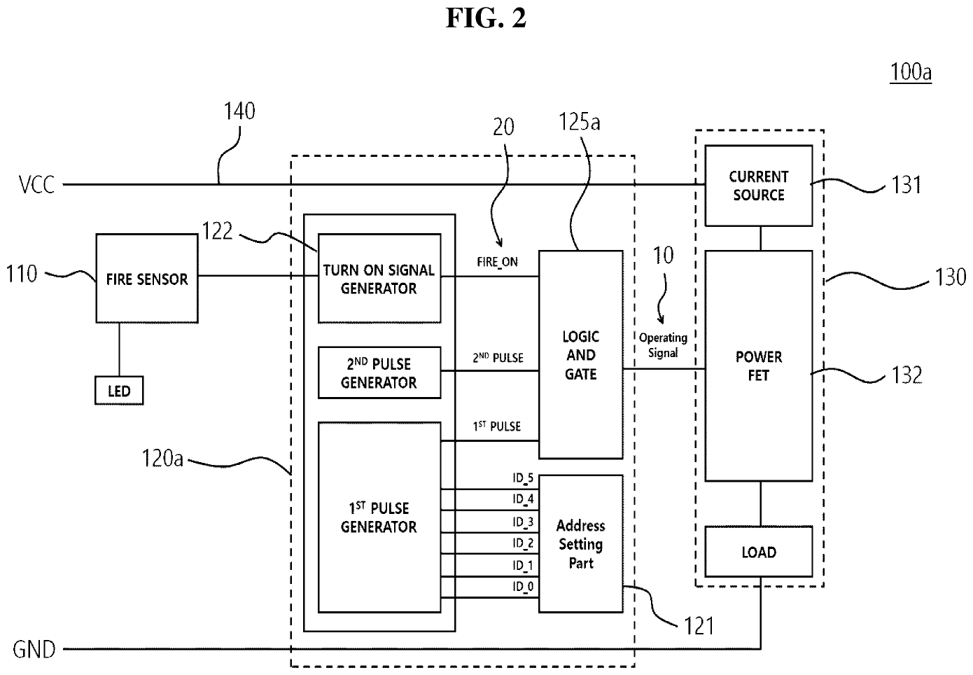

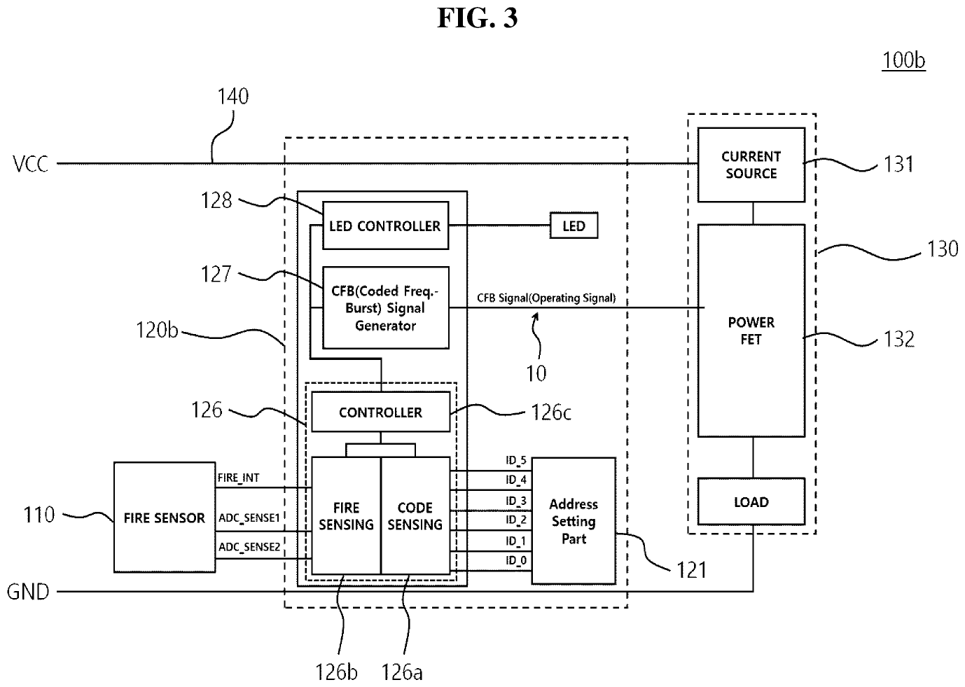

FIG. 1 is a diagram illustrating an example of an address-type fire detection device according to an embodiment of the present disclosure. FIG. 2 is a diagram illustrating another example of an address-type fire detection device according to an embodiment of the present disclosure. FIG. 3 is a diagram illustrating a further example of an address-type fire detection device according to an embodiment of the present disclosure.

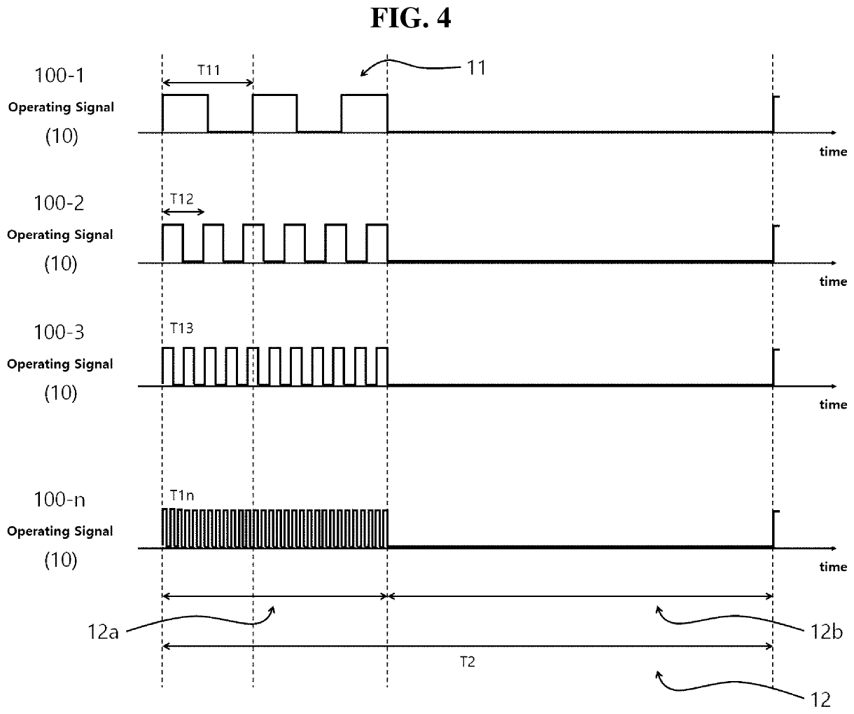

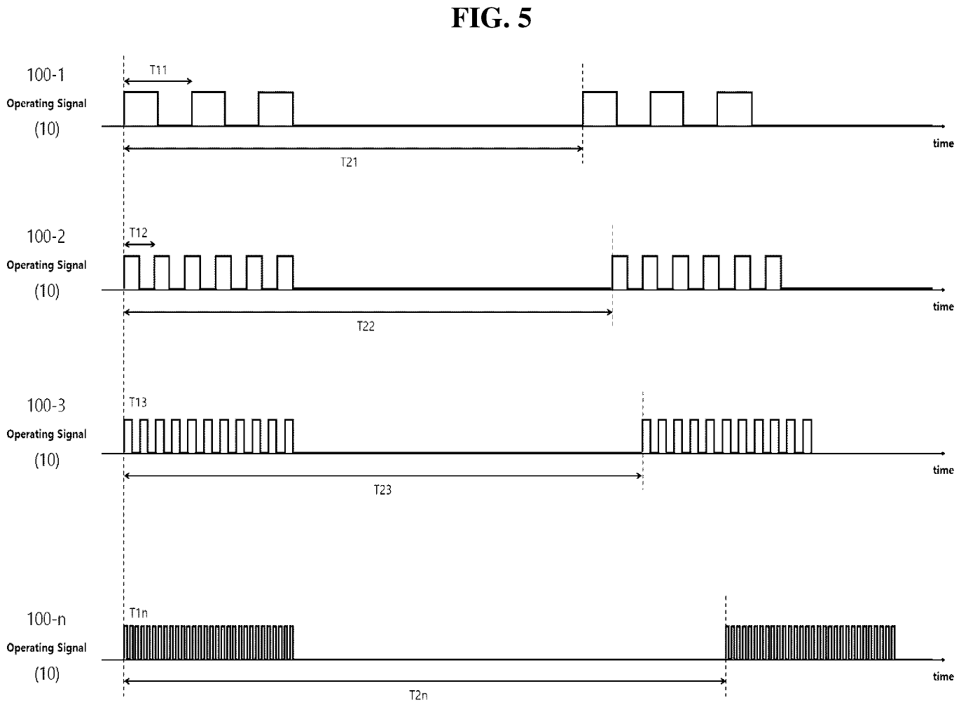

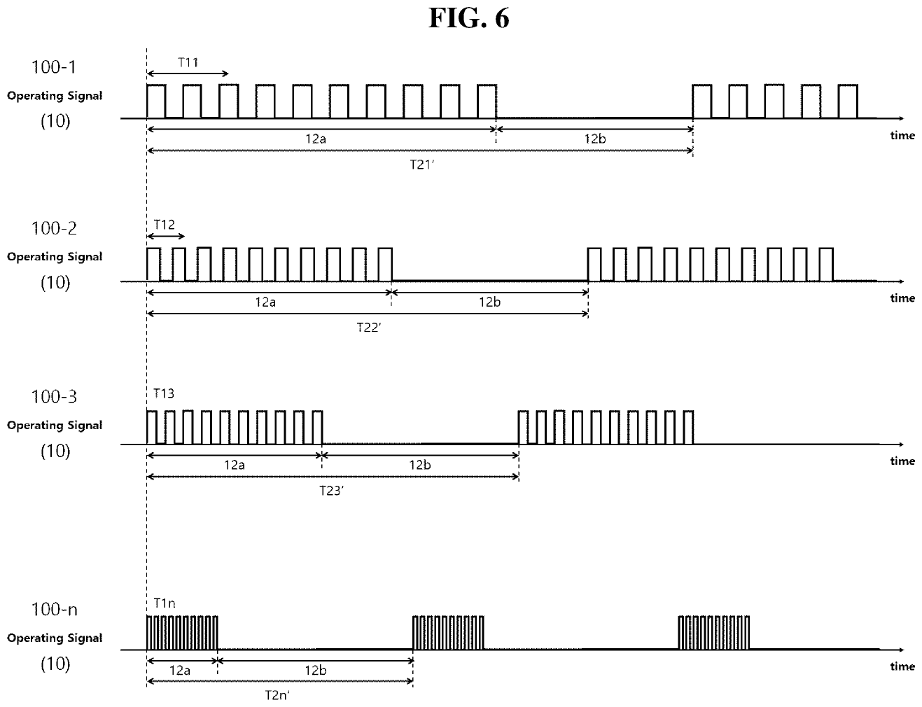

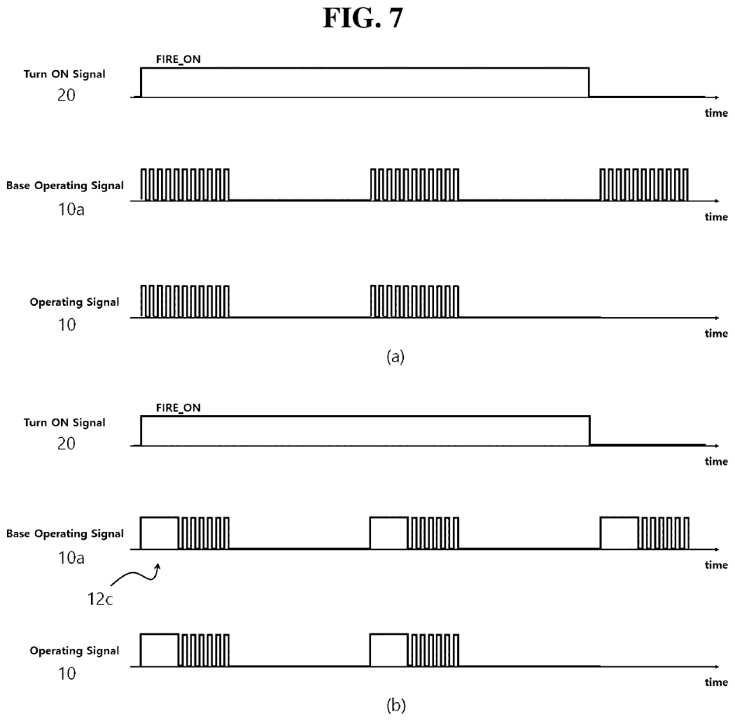

FIGS. 4 to 7 are diagrams illustrating various examples of operation signals generated by an operation signal generating unit according to the present disclosure. FIGS. 4 to 6 are diagrams illustrating a first pulse 11 applied in a pulse-burst to a first section 12a of a second pulse 12. Further, FIGS. 4 to 6 are diagrams illustrating first frequencies of the first pulses 11 having different frequency values according to address values assigned to fire detecting locations where a fire detection sensor of the address-type fire detection device is provided. FIG. 4 is a diagram illustrating second pulses 12 in which frequency values of second frequencies are the same as each other regardless of the address values, and FIG. 4 illustrates a case where the time intervals of the first sections 12a and the time intervals of the second sections 12b are the same as each other regardless of the address values. FIG. 5 is a diagram illustrating second pulses 12 in which frequency values of second frequencies are different from each other according to the address values, and FIG. 5 illustrates a case where the time intervals of the first sections 12a are the same as each other regardless of the address values. FIG. 6 is a diagram illustrating second pulses 12 in which frequency values of second frequencies are different from each other according to the address values, and FIG. 6 illustrates a case where the time intervals of the second sections 12b are the same as each other regardless of the address values. FIG. 7(a) is a diagram in which no startup section 12c is shown, and FIG. 7(b) is a diagram in which the startup section 12c is included in the first section 12a.

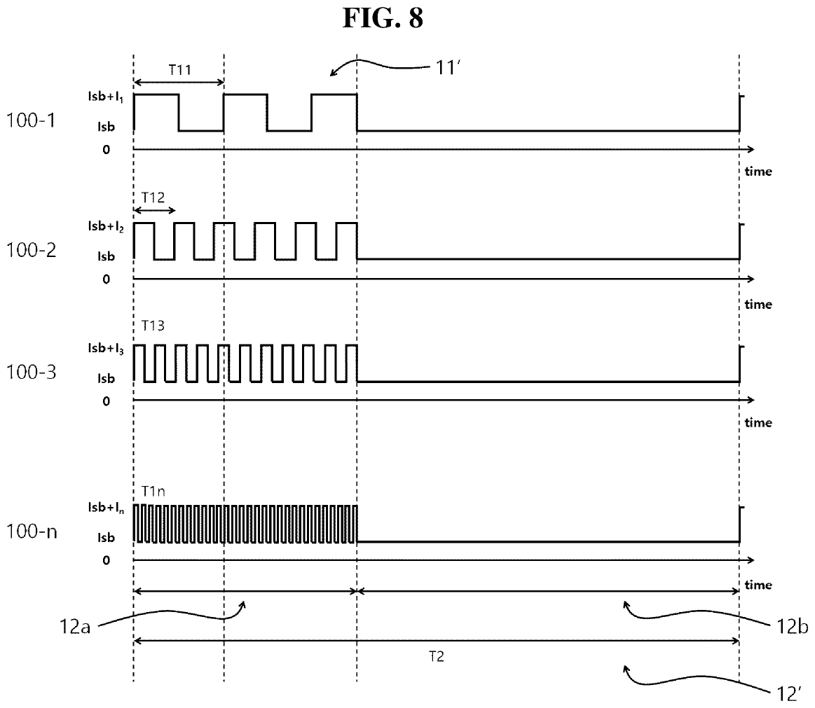

FIGS. 8 to 10 are diagrams illustrating various examples of electrical signals generated by an electrical signal generating unit of the address-type fire detection device according to the present disclosure. FIGS. 8 to 10 are diagrams illustrating the electrical signals including the first frequencies generated by the electrical signal generating unit according to the control of the operation signals of FIGS. 4 to 6, respectively.

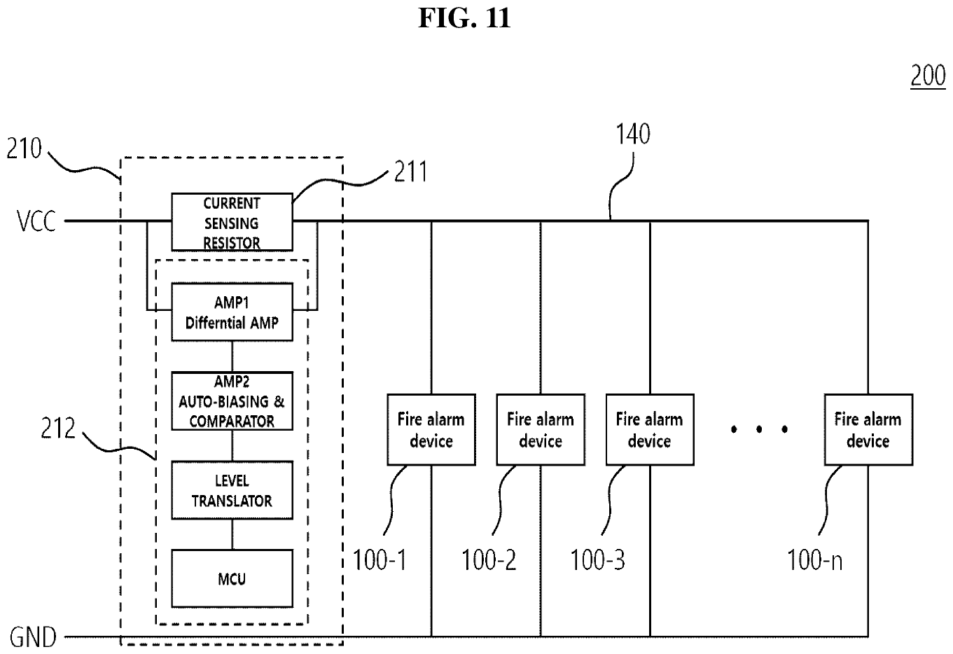

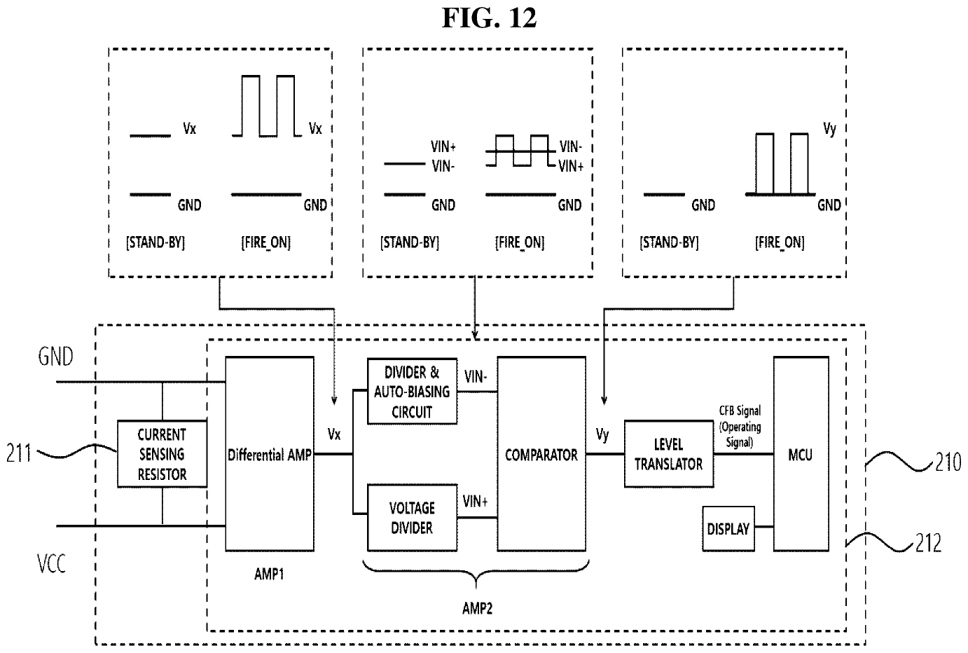

FIG. 11 is a diagram illustrating an example of an address-type fire detection system according to another embodiment of the present disclosure. FIG. 12 is a diagram illustrating an example of a receiving end according to the present disclosure.

Hereinafter, the address-type fire detection device and the address-type fire detection system including the device according to the present disclosure will be described with reference to the drawings.

Referring to FIGS. 1 to 3, the address-type fire detection device 100, 100a, or 100b includes a fire detection sensor 110, an operation signal generating unit 120, 120a, or 120b, and an electrical signal generating unit 130. In some other embodiments, the address-type fire detection device 100, 100-1, 100-2, 100-3, 100-n, or 100a may optionally include a power line 140. The address-type fire detection device 100, 100a, or 100b may include an LED that notifies a user that fire has occurred with light. The user may visually check whether fire has occurred at the location where fire is to be detected through the LED. In addition, the address-type fire detection device 100, 100a, or 100b may include an alarm unit (not shown), and may acoustically notify the user that fire has occurred at the location where fire is to be detected through the alarm unit.

The fire detection sensor 110 is provided at the location where fire is to be detected to detect fire. As the fire detection sensor 110, a temperature sensor, a thermal imaging camera, a gas sensor, etc. may be used. However, the type of the sensor is not limited thereto, as long as it may detect fire.

The operation signal generating unit 120, 120a, or 120b generates an operation signal 10 including the first pulse 11 having the first frequency that is a frequency corresponding to the address value assigned to the location where fire is to be detected if fire is detected through the fire detection sensor 110. The first frequency may have a different value if the address value is changed. Meanwhile, FIGS. 4 to 6 illustrate examples of operation signals 10 generated by address-type fire detection devices 100-1, 100-2, 100-3, and 100-n (n is a natural number) to correspond to different address values assigned to locations where fire is to be detected. The frequency value of the first frequency of the first pulse 11 included in the operation signal 10 may have a different value if the address value is changed. FIGS. 4 to 6 illustrate examples of operation signals 10 having different frequency values 1/T11, 1/T12, 1/T13, and 1/T1n according to different address values. T11, T12, T13, and T1n shown in FIGS. 4 to 6 are period values of the first pulses 11 generated by the address-type fire detection devices 100-1, 100-2, 100-3, and 100-n (n is a natural number), respectively.

The electrical signal generating unit 130 generates an electrical signal including the first frequency according to the control of the operation signal 10.

For example, the operation signal 10 generated by the operation signal generating unit 120, 120a, or 120b may include a second pulse 12 having a second frequency. FIG. 4 illustrates as an example the second frequency 1/T2 generated in the address-type fire detection device 100-1, 100-2, 100-3, or 100-n (n is a natural number). FIG. 4 illustrates as an example the second pulse 12 having the second frequency having the same frequency value regardless of the address value. T2 shown in FIG. 4 is a period value of the second pulse 12. Meanwhile, the second frequency may have a different value if the address value is changed. FIG. 5 illustrates as an example the operation signals 10 having second frequencies 1/T21, 1/T22, 1/T23, and 1/T2n having different frequency values generated in the respective address-type fire detection devices 100-1, 100-2, 100-3, and 100-n (n is a natural number) to correspond to different address values. T21, T22, T23, and T2n shown in FIG. 5 are period values of the second pulse 12 generated in the address-type fire detection devices 100-1, 100-2, 100-3, and 100-n (n is a natural number). Further, FIG. 6 illustrates as an example the operation signals 10 having second frequencies 1/T21′, 1/T22′, 1/T23′, and 1/T2n′ having different frequency values generated in the respective address-type fire detection devices 100-1, 100-2, 100-3, and 100-n (n is a natural number) to correspond to different address values. T21′, T22′, T23′, and T2n′ shown in FIG. 6 are period values of the second pulse 12 generated in the address-type fire detection devices 100-1, 100-2, 100-3, and 100-n (n is a natural number).

In summary, the operation signal 10 generated by the operation signal generating unit 120, 120a, or 120b may include a first pulse 11 and a second pulse 12. In this case, the first frequency may have a greater value than the second frequency. The second pulse 12 may have a first section 12a and a second section 12b. The first pulse 11 may be applied to the first section 12a in the pulse-burst. The electrical signal generating unit 130 may generate the electrical signal including the first frequency by the first pulse 11 applied to the first section 12a.

FIGS. 4 to 6 show as an example a PWM (Pulse Width Modulation) signal having a preset duty for each of the address-type fire detection devices 100-1, 100-2, 100-3, and 100-n (n is a natural number) corresponding to different address values as the second pulse 12. In this case, a section corresponding to a High state of the PWM signal may be the first section 12a, while a section corresponding to a Low state may be the second section 12b. The first section 12a may be an operation section of the electrical signal generating unit 130 in which the electrical signal generating unit 130 generates an electrical signal, and the second section 12b may be a rest section of the electrical signal generating unit 130 in which the electrical signal generating unit 130 generates no electrical signal. As illustrated in FIGS. 4 to 6, the first pulse 11 may be applied in the pulse-burst to the first section 12a that is a section corresponding to the High state of the PWM signal. By applying the first pulse 11 to the first section 12a of the second pulse 12 that is the operation section of the electrical signal generating unit 130 in the pulse-burst, the electrical signal generating unit 130 may generate the electrical signal including the first frequency according to the control of the first pulse 11 of the operation signal 10.

FIG. 4 shows as an example a PWM signal having the same duty regardless of the address value as the second pulse 12. FIGS. 5 and 6 show as an example PWM signals having different duties according to the address value as the second pulse 12. Meanwhile, FIG. 5 shows as an example the PWM signal in which the time interval of the first section 12a is the same regardless of the address value. FIG. 6 shows as an example a case in which the time interval of the second section 12b is the same regardless of the address value. The above example is an example for the purpose of understanding, and the form of the operation signal 10 is not limited as long as the electrical signal including the first frequency may be generated by controlling the electrical signal generating unit 130. Meanwhile, as illustrated in FIG. 6, the number of waves of the first pulse 11 located in the first section 12a may be equally assigned to each of the address-type fire detection devices 100-1, 100-2, 100-3, and 100-n (n is a natural number). When the time interval of the second section 12b is the same regardless of the address value and a predetermined number of waveforms of the first pulse 11 enters the first section 12a for each of the address-type fire detection devices 100-1, 100-2, 100-3, and 100-n (n is a natural number), the duty of the second pulse 120 may be changed for each of the address-type fire detection devices 100-1, 100-2, 100-3, and 100-n (n is a natural number).

As long as a voltage signal may be used as the operation signal 10 but the first frequency may be transmitted to the electrical signal generating unit 130 and the electrical signal generating unit 130 may generate the electrical signal including the first frequency, the operation signal 10 may be a different type of signal such as a current.

For instance, as illustrated in FIG. 1, the operation signal generating unit 120 may include an address setting part 121, a turn on signal generator 122, a first frequency generator 123, a base operation signal generator 124, and a logic and gate 125.

The address setting part 121 may set the address value assigned to the location where fire is to be detected. Although the drawing illustrates the address value having 6-bit codes (ID_0 to ID_5), the present disclosure is not limited thereto.

If fire is detected through the fire detection sensor 110, the turn on signal generator 122 may generate a turn on signal 20 that may operate the electrical signal generating unit 130 as illustrated in FIG. 7.

The first frequency generator 123 may assign the first frequency corresponding to the address value assigned to the location where fire is to be detected.

The base operation signal generator 124 may generate the first pulse 11 having the first frequency and the second pulse 12 having the second frequency, and may generate a base operation signal 10a by applying the first pulse 11 to the first section 12a of the second pulse 12 in the pulse-burst. FIG. 7 illustrates the base operation signal 10a as an example. Meanwhile, the base operation signal 10a may be generated through the base operation signal generator 124 when fire is detected through the fire detection sensor 110 or when a turn on signal is generated, or may be continuously generated through the base operation signal generator 124 in a preset manner regardless of whether the fire is detected through the fire detection sensor 110.

As illustrated in FIG. 7, the logic and gate 125 may combine the turn on signal 20 and the base operation signal 10a by and logic to generate the operation signal 10. Since the logic and gate 125 combines the turn on signal 20 and the base operation signal 10a by and logic to generate the operation signal 10, the electrical signal generating unit 130 may not generate the electrical signal before fire is sensed through the fire detection sensor 110. When the fire is detected through the fire detection sensor 110, the electrical signal generating unit 130 may generate the electrical signal including the first frequency according to the control of the first pulse 11.

As another example, as illustrated in FIG. 2, the operation signal generating unit 120a may include an address setting part 121, a turn on signal generator 122, a first pulse generator, a second pulse generator, and a logic and gate 125.

The address setting part 121 may set the address value assigned to the location where fire is to be detected. Although the drawing illustrates the address value having 6-bit codes (ID_0 to ID_5), the present disclosure is not limited thereto.

If fire is detected through the fire detection sensor 110, the turn on signal generator 122 may generate a turn on signal 20 that may operate the electrical signal generating unit 130 as illustrated in FIG. 7.

The first pulse generator may generate a first pulse 11 including a first frequency corresponding to the address value assigned to the location where fire is to be detected.

The second pulse generator has a second frequency, and may generate a second pulse 12 having a first section 12a and a second section 12b.

Meanwhile, the first pulse 11 and the second pulse 12 may be generated through the first pulse generator and the second pulse generator when fire is detected through the fire detection sensor 110 or the turn on signal is generated, and may be continuously generated through the first pulse generator and the second pulse generator in a preset manner regardless of whether the fire is detected through the fire detection sensor 110.

The logic and gate 125 may combine the turn on signal 20, the first pulse 11, and the second pulse 12 by and logic to generate the operation signal 10. Since the logic and gate 125 combines the turn on signal 20, the first pulse 11, and the second pulse 12 by and logic to generate the operation signal 10, the electrical signal generating unit 130 may not generate the electrical signal before fire is sensed through the fire detection sensor 110. When the fire is detected through the fire detection sensor 110, the electrical signal generating unit 130 may generate the electrical signal including the first frequency according to the control of the first pulse 11.

Meanwhile, as described above, the second pulse 12 may be a PWM (Pulse Width Modulation) signal having a preset duty. In this case, a section corresponding to the High state of the PWM signal may be the first section 12a, while a section corresponding to the Low state may be the second section 12b. The first section 12a may be an operation section of the electrical signal generating unit 130 in which the electrical signal generating unit 130 generates an electrical signal, and the second section 12b may be a rest section of the electrical signal generating unit 130 in which the electrical signal generating unit 130 generates no electrical signal. The first pulse 11 may be applied in the pulse-burst to the first section 12a that is a section corresponding to the High state of the PWM signal by combining the first pulse 11 and the second pulse 12 through and logic. By applying the first pulse 11 to the first section 12a of the second pulse 12 that is the operation section of the electrical signal generating unit 130 in the pulse-burst, the electrical signal generating unit 130 may generate the electrical signal including the first frequency according to the control of the first pulse 11 of the operation signal 10.

As another example, as illustrated in FIG. 3, the operation signal generating unit 120b may include an address setting part 121, a calculation determining part 126, and a pulse-burst signal generator 127. In some other embodiments, the operation signal generating unit 120b may optionally include an LED controller 128.

The address setting part 121 may set an address value assigned to the location where fire is to be detected. Although the drawing illustrates the address value having 6-bit codes (ID_0 to ID_5), the present disclosure is not limited thereto.

The calculation determining part 126 may calculate the first frequency corresponding to the address value and determine whether the operation signal is generated, after receiving the address value set by the address setting part 121 and the fire signal detected through the fire detection sensor 110. FIG. 3 illustrates a calculation determining part 126 including an address-value sensing part 126a, a fire-signal sensing part 126b, and a controller 126c. The address-value sensing part 126a may detect an address value that is set by the address setting part 121, and the fire-signal sensing part 126b may receive a fire signal through the fire detection sensor 110. The controller 126c may calculate the first frequency of the first pulse 11, the second frequency of the second pulse 12, and the duty of the second pulse 12 based on the address value received from the address-value sensing part 126a and the fire signal detected by the fire-signal sensing part 126b. The controller 126c may control the pulse-burst signal generator 127 according to the calculated result. Further, the controller 126c may control the LED controller 128 according to the calculated result.

The pulse-burst signal generator 127 may generate the operation signal 10 according to the control of the calculation determining part 126. The pulse-burst signal generator 127 may generate the first pulse 11 having the first frequency and the second pulse 12 having the second frequency, and may generate the operation signal 10 by applying the first pulse 11 to the first section 12a of the second pulse 12 in the pulse-burst. Since the operation signal 10 is provided such that the first pulse 11 having the first frequency is applied to the first section 12a of the second pulse 12 having the second frequency in the pulse-burst, the operation signal 10 may be referred to as a CFB (Coded Freq. Burst) Signal in the present disclosure.

Meanwhile, if fire is detected by the fire detection sensor 110, the calculation determining part 126 may turn on/off a POWER FET, which is an example of a switch 132, with the burst signal of a preset channel frequency corresponding to the address value of the address setting part 121, that is, the first frequency of the first pulse 11 to control a constant current and operate an LED. The LED may remain in its state even when the address-type fire detection device 100b returns to its normal state. The reset of the LED may be cleared by turning the power off/on or with a reset button. That is, the LED causes an operator to visit a place where fire is detected and directly turn off the LED, thus causing the operator to directly check a location where fire is to be detected where the fire has occurred without relying on a system, and thereby forcing the operator to check whether the fire has actually occurred. Further, when the device and the system disclosed in the present disclosure malfunction, the LED may provide the function of allowing the operator to easily find the malfunctioning address-type fire detection device.

Further, as illustrated in FIG. 7(b), the operation signal 10 generated by the operation signal generating unit 120 or 120a may include a startup section 12c for the stable operation or initial operation of the electrical signal generating unit 130.

As illustrated in FIGS. 1 to 3, the electrical signal generating unit 130 may include a current source 131 that provides current, and a switch 132 that is connected to the current source 131 to turn on or off the supply of current that is provided by the current source 131. In this case, the operation signal 10 including the first pulse 11 having the first frequency may be applied as the switching signal of the switch 132. The electrical signal including the first frequency, which is generated by the electrical signal generating unit 130, may be reflected in the form of a change in a current value of the current provided by the current source 131.

A constant current source may be used as an example of the current source 131, but the present disclosure is not limited thereto. A power FET or a power FET having the gate signal or the base signal as the operation signal 10 may be used as the switch 132, but the present disclosure is not limited thereto.

Meanwhile, as illustrated in FIGS. 1 to 3, it is assumed that the current source 131 providing current and the switch 132 connected to the current source 131 and turning on and off the supply of the current provided by the current source 131 are utilized as the electrical signal generating unit 130.

Each of the signals shown in FIGS. 4 to 6 may be applied as the operation signal 10 to the electrical signal generating unit 130 of the address-type fire detection device 100-1, 100-2, 100-3, or 100-n. In this case, the applied operation signal 10 may be a voltage signal that turns on or off the switch 132 of the electrical signal generating unit 130 as an example. If each of the signals shown in FIGS. 4 to 6 may be applied as the operation signal 10 to the switch 132 of the electrical signal generating unit 130 of the address-type fire detection device 100-1, 100-2, 100-3, or 100-n, the electrical signal generating unit 130 of the address-type fire detection device 100-1, 100-2, 100-3, or 100-n may generate the current signal shown in FIGS. 8 to 10 as the electrical signal. In FIGS. 8 to 10, Isb is a standby current flowing through the address-type fire detection device 100-1, 100-2, 100-3, or 100-n in a standby state where VCC power is supplied, and I1, I2, I3, and In denote currents flowing through the address-type fire detection devices 100-1, 100-2, 100-3, and 100-n, respectively, when fire is detected in the event of fire.

That is, since the switch 132 is controlled according to the first frequency of the operation signal 10 if the operation signal 10 including the first pulse 11 having the first frequency is applied to the switching signal of the switch 132, the current provided from the current source 131 is also controlled according to the first frequency of the operation signal 10. The electrical signal including the first frequency, generated by the electrical signal generating unit 130, may be reflected in the form of a change in the current value of the current provided by the current source 131. Thereby, the electrical signal generating unit 130 may generate the electrical signal including the first frequency according to the control of the operation signal 10 including the first pulse 11 having the first frequency.

The power line 140 may supply power required for operating the electrical signal generating unit 130. In this case, the electrical signal including the first frequency, generated by the electrical signal generating unit 130, may be provided to the power line 140. Thereby, the address-type fire detection device 100 according to the present disclosure controls the electrical signal generating unit 130 through the operation signal 10 that is generated by the operation signal generating unit 120 and includes the first pulse 11 having the first frequency that is a frequency corresponding to the address value, thus generating the electrical signal including the first frequency, and supplying the generated electrical signal through the power line 140 to the outside, and thereby detecting a location where fire has occurred only with the power line 140 without the necessity of providing a separate communication line or communication equipment.

The power required for operating the fire detection sensor 110 and the operation signal generating unit 120, 120a, or 120b may also be supplied through the power line 140.

Referring to FIG. 11, the address-type fire detection system 200 includes a plurality of address-type fire detection devices 100-1, 100-2, 100-3, and 100-n, a power line 140, and a receiving part 210.

The plurality of address-type fire detection devices 100-1, 100-2, 100-3, and 100-n are distributed and provided for the locations where fire is to be detected, respectively, and a different address value is assigned to each distributed location.

The power line 140 is connected to the plurality of address-type fire detection devices 100-1, 100-2, 100-3, and 100-n to supply power required for the operation. That is, the power line 140 is connected to a plurality of address-type fire detection devices 100-1, 100-2, 100-3, and 100-n, especially, the electrical signal generating unit 130 to supply power required for the operation of the plurality of address-type fire detection devices 100-1, 100-2, 100-3, and 100-n, especially the electrical signal generating unit 130.

The receiving part 210 is connected to the power line 140 to determine whether fire occurs for each location where fire is to be detected.

Each of the plurality of address-type fire detection devices 100-1, 100-2, 100-3, and 100-n includes a fire detection sensor 110 that is provided on the location where fire is to be detected, so as to detect fire, an operation signal generating unit 120, 120a, or 120b that generates the operation signal 10 including the first pulse 11 having the first frequency that is the frequency corresponding to the address value assigned to the location where fire is to be detected if fire is detected by the fire detection sensor 110, and an electrical signal generating unit 130 that generates an electrical signal including the first frequency according to the control of the operation signal 10. In this case, the first frequency has different frequency values if the address values are different from each other, and the electrical signal including the first frequency, generated by the electrical signal generating unit 130, is provided through the power line 140.

Since the address-type fire detection devices 100, 100a, and 100b described above with reference to FIGS. 1 to 10 may be applied to the plurality of address-type fire detection devices 100-1, 100-2, 100-3, and 100-n and are substantially equal to each other, a detailed description thereof will be omitted for the convenience of description.

That is, contents common to both the address-type fire detection system 200 and the above address-type fire detection devices 100, 100a, and 100b will be omitted for the convenience of description in the detailed description of the address-type fire detection system. Hereinafter, the characteristic operation and configuration of the address-type fire detection system 200 will be mainly described.

For example, the electrical signal including the first frequency, generated by the electrical signal generating unit 130, may include a current provided to the power line 140. As illustrated in FIG. 11, the electrical signal generating unit 130 of each of the plurality of address-type fire detection devices 100-1, 100-2, 100-3, and 100-n may be electrically connected in parallel to the power line 140.

In this case, the receiving part 210 may include a voltage conversion part 211 that is connected to the power line 140 to convert current flowing through the power line 140 to voltage, and a fire determination part 212 that analyzes the frequency of the voltage converted by the voltage conversion part 211 and then determines whether fire occurs for each location where fire is to be detected from the analyzed frequency of the voltage.

FIGS. 11 and 12 show an example of the receiving part 210. Referring to FIGS. 11 and 12, the receiving part 210 may include a current sensing resistor as an example of the voltage conversion part 211. Further, the receiving part 210 may include a first amplifier AMP1, a differential amplifier, a second amplifier AMP2, a level translator, and a micro control unit MCU as an example of the fire determination part 212. Further, the receiving part 210 may include a display that shows the determination result of the fire determination part 212.

Hereinafter, the operation of the address-type fire detection system 200 according to the present disclosure will be described with reference to FIGS. 11 and 12.

If fire is detected by the fire detection sensor 110 of any one of the plurality of address-type fire detection devices 100-1, 100-2, 100-3, and 100-n provided in the locations where fire is to be detected, the operation signal generating unit 120, 120a, or 120b of the address-type fire detection device detecting fire (hereinafter referred to as a fire-site detection device) generates the operation signal 10 including the first pulse 11 having the first frequency (hereinafter referred to as a fire-site first frequency) that is a frequency corresponding to the address value that is assigned to the location where fire is to be detected. The operation signal 10 generated by the operation signal generating unit 120, 120a, or 120b of the fire-site detection device controls the electrical signal generating unit 130 of the fire-site detection device, generates current including the fire-site first frequency as the electrical signal, and then provides it through the power line 140.

As illustrated in FIG. 12, the current including the fire-site first frequency, which is provided through the power line 140, is provided to the current sensing resistor 211, so that voltage is generated at both ends of the current sensing resistor 211. At this time, since the voltage generated at both ends of the current sensing resistor 211 is attributable to the current including the fire-site first frequency, which is provided through the power line 140, the voltage includes the fire-site first frequency. The voltage generated at both ends of the current sensing resistor 211 is amplified (Vx) by the first amplifier AMP1 to be provided to the second amplifier AMP2.

FIG. 12 shows Vx in a standby state (STAND-BY) before fire occurs and Vx in a fire-on state (FIRE_ON). As described above, Vx in the fire-on state (FIRE_ON) includes the fire-site first frequency.

Vx obtained via the first amplifier AMP1 is provided to the second amplifier AMP2. The second amplifier AMP2 may include a voltage divider & auto-biasing circuit, a voltage divider, and a comparator. Vx passing through the second amplifier AMP2 is converted into Vy from which the effect of Isb (see FIGS. 8 to 10) that is the current of the standby state is removed. Vy may be translated into a voltage level required by the micro control unit (MCU) through the level translator. The voltage level required by the micro control unit (MCU) may be the CFB (Coded Freq. Burst) signal that is the operation signal 10. The micro control unit (MCU) may extract the first frequency from Vy passing through the level translator. The present disclosure proposes technology in which the address value may be found from the extracted first frequency, so that the fire occurrence may be checked for each location where fire is to be detected.

The foregoing is only one example. The electrical signal generating unit 130 of the plurality of address-type fire detection devices 100-1, 100-2, 100-3, and 100-n may generate the voltage signal as the electrical signal including the first frequency, and the receiving part 210 may directly convert the voltage signal into the current signal, extract the first frequency, and check fire occurrence for each location where fire is to be detected.

Hereinafter, the operation of the address-type fire detection device 100, 100-1, 100-2, 100-3, 100-n, 100a, or 100b and the address-type fire detection system 200 according to the present disclosure will be described in brief with reference to the drawing.

The address-type fire detection devices 100, 100-1, 100-2, 100-3, 100-n, 100a, and 100b according to the present disclosure assign different address values to the locations where fire is to be detected, so as to detect fire. When fire is detected through the address-type fire detection devices 100, 100-1, 100-2, 100-3, 100-n, 100a, and 100b to which different address values are given, the address-type fire detection device 100, 100-1, 100-2, 100-3, 100-n, 100a, or 100b generates the electrical signal having the first frequency. In this case, the first frequency has different frequency values when the address values are different. The electrical signal including the first frequency, which is generated by the address-type fire detection device 100, 100-1, 100-2, 100-3, 100-n, 100a, or 100b, may be supplied through the power line 140 to the receiving part 210. Thereby, the receiving part 210 may check whether fire occurs for each location where fire is to be detected by extracting and analyzing the first frequency of the electrical signal supplied by the address-type fire detection device 100, 100-1, 100-2, 100-3, 100-n, 100a, or 100b.

Meanwhile, fires may simultaneously occur in several places among the locations where fire is to be detected. In this case, as illustrated in FIG. 8, the electrical signal including the first frequency having a different frequency value supplied by the electrical signal generating unit 130 of the address-type fire detection device 100-1, 100-2, 100-3, or 100-n detecting the fire may be supplied to the receiving part 210. In this case, it is possible to check whether fire occurs for each location where fire is to be detected by extracting and analyzing the frequency value of the first frequency of the electrical signal supplied by the address-type fire detection device 100-1, 100-2, 100-3, or 100-n through frequency filtering.

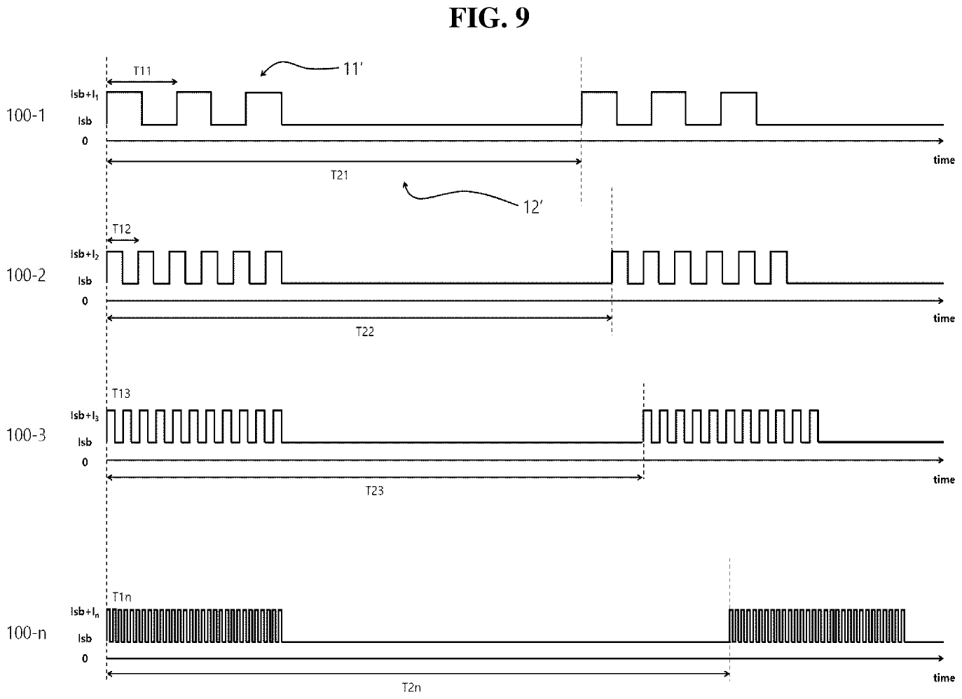

Furthermore, as illustrated in FIG. 5, the second frequencies 1/T21, 1/T22, 1/T23, and 1/T2n of the operation signal 10 of the address-type fire detection devices 100-1, 100-2, 100-3, and 100-n may be provided to have different frequency values when the address values are different from each other. Fires may simultaneously occur in several places among the locations where fire is to be detected. In this case, as illustrated in FIG. 9, the electrical signal including the first frequency and the second frequency having different frequency values, supplied by the electrical signal generating unit 130 of the address-type fire detection device 100-1, 100-2, 100-3, or 100-n detecting the fire, may be supplied to the receiving part 210. In this case, as soon as the first frequency of the electrical signal supplied by the address-type fire detection device 100-1, 100-2, 100-3, or 100-n reaches the receiving part 210, it may be immediately analyzed. Alternatively, when the first frequency of the electrical signal supplied by the address-type fire detection device 100-1, 100-2, 100-3, or 100-n reaches the receiving part 210, it may not be immediately analyzed, but extraction and analysis may be performed after a predetermined period of time has elapsed. Thus, the electrical signals provided by the address-type fire detection devices 100-1, 100-2, 100-3, and 100-n may be separated from each other without frequency filtering, and then the first frequencies of the electrical signals may be extracted and analyzed, so that it is possible to check whether fire has occurred for each location where fire is to be detected. This is based on a reason that the frequency values of the second frequency are provided to have different values when the address values are different from each other. Specifically, when fires simultaneously occur in several places among the locations where fire is to be detected, the address-type fire detection devices 100-1, 100-2, 100-3, and 100-n detecting the fires may supply the electrical signal through the power line 140 to the receiving part 210. At first, all of the first pulses 11′ having the first frequency among the electrical signals arriving at the receiving part 210 may reach at the same time. However, since the frequency values of the second frequency of the electrical signals supplied by the address-type fire detection devices 100-1, 100-2, 100-3, and 100-n are different from each other, the first pulses 11′ having the first frequency among the electrical signals supplied by the address-type fire detection devices 100-1, 100-2, 100-3, and 100-n arrive at the receiving part 210 at different times as time passes. Thereby, it is possible to check whether fire has occurred for each location where fire is to be detected, by extracting and analyzing the first frequency of the electrical signal that is supplied by each of the address-type fire detection devices 100-1, 100-2, 100-3, and 100-n without frequency filtering.

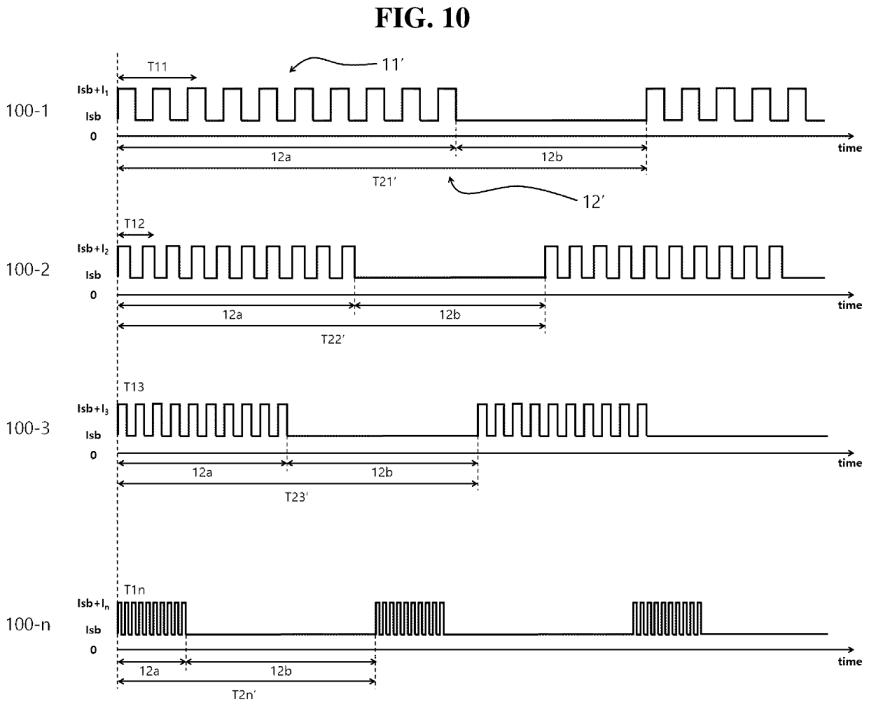

Further, as illustrated in FIG. 6, the second frequencies 1/T21′, 1/T22′, 1/T23′, and 1/T2n′ of the operation signal 10 of the address-type fire detection devices 100-1, 100-2, 100-3, and 100-n may be provided to have different frequency values when the address values are different from each other. Fires may simultaneously occur in several places among the locations where fire is to be detected. In this case, as illustrated in FIG. 10, the electrical signal including the first frequency and the second frequency having different frequency values, supplied by the electrical signal generating unit 130 of the address-type fire detection device 100-1, 100-2, 100-3, or 100-n detecting the fire, may be supplied to the receiving part 210. In this case, as soon as the first frequency of the electrical signal supplied by the address-type fire detection device 100-1, 100-2, 100-3, or 100-n reaches the receiving part 210, it may be immediately analyzed. Alternatively, when the first frequency of the electrical signal supplied by the address-type fire detection device 100-1, 100-2, 100-3, or 100-n reaches the receiving part 210, it may not be immediately analyzed, but extraction and analysis may be performed after a predetermined period of time has elapsed. Thus, the electrical signals provided by the address-type fire detection devices 100-1, 100-2, 100-3, and 100-n may be separated from each other without frequency filtering, and then the first frequencies of the electrical signals may be extracted and analyzed, so that it is possible to check whether fire has occurred for each location where fire is to be detected. Since a detailed description thereof is the same as the detailed description of FIGS. 5 and 9, it will be omitted for the convenience of explanation.

As described above, the present disclosure is advantageous in that an electrical signal including a first frequency is generated by controlling an electrical signal generating unit through an operation signal that is generated by an operation signal generating unit and includes a first pulse having the first frequency that is a frequency corresponding to an address value, thus facilitating an operation only by a power line.

Further, the present disclosure is advantageous in that it is possible to check whether fire has occurred for each location where fire is to be detected only by analyzing a frequency at a receiving end using a first frequency having a different frequency value for each address value.

Further, the present disclosure is advantageous in that it is possible to check whether fire has occurred for each location where fire is to be detected only by analyzing a frequency even if fires have simultaneously occurred at a plurality of locations where fire is to be detected, through an operation signal including a second frequency having a different frequency value for each address value.

In other words, according to the present disclosure, the address is assigned with the frequency, i.e., the first frequency to each address-type fire detection device 100-1, 100-2, 100-3, or 100-n, and the electrical signal generated by each address-type fire detection device 100-1, 100-2, 100-3, or 100-n is transmitted through the power line 140 to the receiving part 210, so that a signal resistant to noise can be transmitted to the receiving part 210 and this can be easily detected by the receiving part 210. Further, according to the present disclosure, the length of the first section 12a of the second pulse 12 is set to be shorter than that of the second section 12b, and the signal of the first pulse 11 of a specific frequency, i.e., the first frequency is sent in the pulse-burst manner only for a very short time compared to a period, i.e. a period of the second frequency, thus providing characteristics that facilitate multi-channel detection. In addition, if the period of the second frequency is changed in conjunction with the first frequency of each address-type fire detection device 100-1, 100-2, 100-3, or 100-n, the address-type fire detection devices 100-1, 100-2, 100-3, and 100-n are simultaneously turned on, so that the first pulses 11′ of the electrical signals of the address-type fire detection devices 100-1, 100-2, 100-3, and 100-n which reach the receiving part 210 at first may overlap each other. Even in this case, the first pulses 11′ of the electrical signals of the address-type fire detection devices 100-1, 100-2, 100-3, and 100-n which reach the receiving part 210 are separated from each other after a certain cycle of the second frequency (within 2 to 3 cycles). Thereby, according to the present disclosure, even if fires occur simultaneously, the first pulses 11′ of the electrical signals of the address-type fire detection devices 100-1, 100-2, 100-3, and 100-n can be easily detected by the receiving part 210.

The period of the second pulse 12′ of the electrical signal of each of the address-type fire detection devices 100-1, 100-2, 100-3, and 100-n provided to the receiving part 210 may be changed depending on the number of the first pulse 11′ of the electrical signal of each of the address-type fire detection devices 100-1, 100-2, 100-3, and 100-n detected by the receiving part 210. The period of the second pulse 12′ of the electrical signal of each of the address-type fire detection device 100-1, 100-2, 100-3, and 100-n and the number of the first pulses 11′ may be adjusted by adjusting the period of the second pulse 12 of the operation signal 10 of each of the address-type fire detection devices 100-1, 100-2, 100-3, and 100-n and the number of the first pulses 11.

For instance, as shown in FIGS. 6 and 10, the first pulse 11 of the operation signal 10 of each of the address-type fire detection devices 100-1, 100-2, 100-3, and 100-n and the first pulse 11′ of the electrical signal depending on the first pulse 11 of the operation signal 10 have a predetermined number of pulses. The drawing illustrates the first pulses 11 of ten operation signals 10 and the first pulse 11′ of the electrical signal. The second sections 12b of the second pulses 12′ of the electrical signals of the address-type fire detection devices 100-1, 100-2, 100-3, and 100-n are set to be the same as each other, and the same number of the first pulses 11′ of the electrical signal is applied in the pulse-burst to the first sections 12a of the second pulses 12′ of the electrical signals of the address-type fire detection devices 100-1, 100-2, 100-3, and 100-n, so that the periods of the address-type fire detection devices 100-1, 100-2, 100-3, and 100-n may become different from each other.

Meanwhile, the period of the second pulse 12′ of the electrical signal of each of the address-type fire detection device 100-1, 100-2, 100-3, and 100-n detected by the receiving part 210 and the number of the first pulses 11′ have a trade-off relationship in determining the accuracy, detection time, and number of multiple detections of the address-type fire detection system 200 according to the present disclosure. That is, as the number of the first pulses 11′ of the electrical signal detected by the receiving part 210 increases, the accuracy of the address-type fire detection system 200 according to the present disclosure increases. On the other hand, when the second sections 12b of the second pulses 12′ of the electrical signals of the address-type fire detection devices 100-1, 100-2, 100-3, and 100-n are set to be the same as each other, the period of the electrical signal of each of the address-type fire detection devices 100-1, 100-2, 100-3, and 100-n becomes longer as the number of the first pulses 11′ of the electrical signal detected by the receiving part 210 increases. Thus, in the event of simultaneous fires, when the first pulses 11′ of the electrical signals of the address-type fire detection devices 100-1, 100-2, 100-3, and 100-n which reach the receiving part 210 are separated from each other after a certain cycle of the second frequency of each of the address-type fire detection devices 100-1, 100-2, 100-3, and 100-n has passed, the separation time for separating the first pulses 11′ of the electrical signals of the address-type fire detection devices 100-1, 100-2, 100-3, and 100-n, that is, the detection time becomes longer. Since the detection time increases as the number of multiple detections increases, the period of the second pulse 12′ of the electrical signal of each of the address-type fire detection device 100-1, 100-2, 100-3, and 100-n detected by the receiving part 210 and the number of the first pulses 11′ need to be determined in consideration of the accuracy, detection time, and number of multiple detections of the address-type fire detection system 200.

From the above, various embodiments of the present disclosure have been described for purposes of illustration, and it will be understood that various modifications are present without departing from the scope and spirit of the present disclosure. Furthermore, various embodiments are not intended to limit the spirit of the present disclosure, and the true spirit and scope will be presented from the following claims.

1. An address-type fire detection device comprising:
a fire detection sensor provided at a location where fire is to be detected, so as to detect fire;
an operation signal generating unit for generating, when fire is detected through the fire detection sensor, an operation signal including a first pulse that has a first frequency corresponding to an address value assigned to the location where fire is to be detected; and
an electrical signal generating unit for generating an electrical signal, including the first frequency, according to the control of the operation signal.

2. The address-type fire detection device of claim 1, wherein the operation signal generated by the operation signal generating unit comprises a second pulse having a second frequency,
the first frequency has a value greater than the second frequency,
the second pulse has a first section and a second section,
the first pulse is applied in a pulse-burst to the first section, and
the electrical signal generating unit generates the electrical signal including the first frequency by the first pulse applied to the first section.

3. The address-type fire detection device of claim 2, wherein the operation signal generating unit comprises:
an address setting part setting the address value assigned to the location where fire is to be detected;
a calculation determining part calculating the first frequency corresponding to the address value and determining whether the operation signal is generated, after receiving the address value set by the address setting part and the fire signal detected through the fire detection sensor; and
a pulse-burst signal generator generating the operation signal according to the control of the calculation determining part,
wherein the pulse-burst signal generator generates the first pulse having the first frequency and the second pulse having the second frequency, and generates the operation signal by applying the first pulse to the first section of the second pulse in the pulse-burst.

4. The address-type fire detection device of claim 1, wherein the electrical signal generating unit comprises:
a current source providing a current; and
a switch connected to the current source to turn on or off the supply of the current that is provided by the current source,
the operation signal is applied as a switching signal of the switch, and
the electrical signal including the first frequency, which is generated by the electrical signal generating unit, is reflected in the form of a change in a current value of the current provided by the current source.

5. The address-type fire detection device of claim 1, further comprising:
a power line supplying power required for operating the electrical signal generating unit,
the electrical signal including the first frequency, generated by the electrical signal generating unit, is provided to the power line.

6. An address-type fire detection system comprising:
a plurality of address-type fire detection devices which are distributed according to a location where fire is to be detected, and to which different address values are assigned by distributed location;
a power line connected to the plurality of address-type fire detection devices to supply power required for operation; and
a receiving part connected to the power line to determine whether fire has broken out at each location where fire is to be detected,
wherein each of the plurality of address-type fire detection devices comprises:
a fire detection sensor provided at a location where fire is to be detected, so as to detect fire;
an operation signal generating unit generating an operation signal including a first pulse having a first frequency that is a frequency corresponding to the address value assigned to the location where fire is to be detected, if fire is detected by the fire detection sensor; and
an electrical signal generating unit generating an electrical signal including the first frequency according to the control of the operation signal,
the first frequency has different frequency values if the address values are different from each other, and
the electrical signal including the first frequency, generated by the electrical signal generating unit, is provided through the power line.

7. The address-type fire detection system of claim 6, wherein the operation signal generated by the operation signal generating unit comprises a second pulse having a second frequency,
the first frequency has a value greater than the second frequency,
the second pulse has a first section and a second section,
the first pulse is applied in a pulse-burst to the first section, and
the electrical signal generating unit generates the electrical signal including the first frequency by the first pulse applied to the first section.

8. The address-type fire detection system of claim 7, wherein the operation signal generating unit comprises:
an address setting part setting the address value assigned to the location where fire is to be detected;
a calculation determining part calculating the first frequency corresponding to the address value and determining whether the operation signal is generated, after receiving the address value set by the address setting part and the fire signal detected through the fire detection sensor; and
a pulse-burst signal generator generating the operation signal according to the control of the calculation determining part,
wherein the pulse-burst signal generator generates the first pulse having the first frequency and the second pulse having the second frequency, and generates the operation signal by applying the first pulse to the first section of the second pulse in the pulse-burst.

9. The address-type fire detection system of claim 7, wherein the second frequency has different frequency values if the address values are different from each other

10. The address-type fire detection system of claim 6, wherein the electrical signal including the first frequency, generated by the electrical signal generating unit, comprises a current provided to the power line, and
the electrical signal generating unit of each of the plurality of address-type fire detection devices is electrically connected in parallel to the power line.

11. The address-type fire detection system of claim 10, wherein the receiving part comprises:
a voltage conversion part connected to the power line to convert the current flowing through the power line to voltage; and
a fire determination part analyzing the frequency of the voltage converted by the voltage conversion part and then determining whether fire occurs for each location where fire is to be detected, from the analyzed frequency of the voltage.

12. The address-type fire detection system of claim 6, wherein the electrical signal generating unit comprises:
a current source connected to the power line to provide a current to the power line; and
a switch connected to the current source to turn on or off the supply of the current that is provided by the current source,
the operation signal is applied as a switching signal of the switch, and
the electrical signal including the first frequency, which is generated by the electrical signal generating unit, is reflected in the form of a change in a current value of the current provided to the power line by the current source.
